(19) United States
(12) Patent Application Publication
(10) Pub. No.: US 2006/0089118 A1
(43) Pub. Date: Apr. 27, 2006

(54) System and method for automated identification of end user devices by a universal remote control device

(76) Inventor: Thomas Whitehouse, Bethlehem, GA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 10/970,563

(22) Filed: Oct. 21, 2004

(51) Int. Cl. H04B 1/18; H04B 1/06; H04N 5/44

(52) U.S. Cl. 455/352; 455/151.1; 348/734

(57) ABSTRACT

A system and method for more efficient and simple configuration of a universal remote control device is disclosed. The inventive system and method includes a universal remote control device which incorporates a transceiver. Further, end user devices, which the universal remote control issues function command include a transceiver. The universal remote control device polls end user devices, for each type of supported end user device, with a query that is unique for each type of end user device. In response to such polling, each polled end user device responds to the universal remote control device with its unique device identifier code. The universal remote control device, using the received unique device identifier code, automatically programs/configures itself to transmit commands to the respective end user devices.

### FIELD OF THE INVENTION

The present invention relates to remote control devices. More specifically, the present invention relates to the learning/programming/configuration of a universal remote control device.

### BACKGROUND OF THE INVENTION

Remote control devices have existed for countless years. Remote control devices premiered as a way to control a television set such that the end user need not physically actuate buttons on the television to control the television's functions, e.g., changing the channel, volume control, etc. Rather, the end user could manipulate such functions remotely from their viewing position via a remote control device.

Today remote control devices are used to control almost every end user device related to entertainment. Such end user devices include televisions, and other video display sources; broadcast tuners, such as cable set top boxes or satellite tuners; digital video disc (“DVD”) players; video cassette recorders (“VCR”); and digital video recorders (“DVR” or “PVR”), for example.

To alleviate having to use a plurality of remote controls (one remote control for each end user device), universal remote control devices were developed. A universal remote control device allows an end user to use one generic remote control device to control a plurality of end user devices capable of being remotely controlled (“remote controlled devices”), instead of many device specific remote control devices.

Since each end user has different types of remote controlled devices and from a variety of different manufacturers, a universal remote control device needs to be configured to command the specific remote controlled devices of each end user.

Conventionally an end user can configure a universal remote by performing one of two “learning” techniques. One learning technique requires the end user to find a code pertaining to each of the end user's remote controlled devices. This is conventional performed by the end user looking up device specific codes in a universal remote control's manual or other look-up table (Internet web site of universal remote control device's manufacturer), or by using a scanning function on the universal remote control device, where the universal remote control device scans until it emanates a command that effects a remote controlled device, e.g., “power off”, at which point the end user stops the scan, since the code for that remote controlled device has been found.

Another conventional method is for the end user to program each command of each of the plurality of remote controlled devices' specific individual remote controls into the universal remote control device by aiming each device specific remote control into a receiver on the universal remote control device, and assigning a physical key on the universal remote control device for each physical key and corresponding code on the device specific remote control.

The above learning/programming/configuration can take a great deal of time. Further, if the universal remote control device's battery dies, many universal remote control devices fail to retain the device specific codes and, thus, the learning/programming/configuration, as described above, must be performed again by the end user.

There exists a need for a more efficient and more simple system and method for configuring a universal remote control device.

### SUMMARY OF INVENTION

An object of the present invention is to provide an efficient and simple system and method for configuring a universal remote control device.

In order to achieve this objective, as well as others which will become apparent in the disclosure below, the present invention provides for an inventive universal remote control device which incorporates a transceiver. Further, each remote controlled device, which the inventive universal remote control issues (transmits) commands, includes a transceiver. In accordance with an exemplary embodiment of the present invention, the inventive universal remote control device polls remote controlled device(s) for each type of supported remote controlled device, e.g., television, DVD, PVR, VCR, etc., with a query that is unique for each type of device. In response to such poll, each polled remote controlled device responds to the inventive universal remote control device with its unique remote controlled device identifier (based upon make and model of the remote controlled device). In response to, and using, the received unique remote controlled device identifier(s), the inventive universal remote control device automatically programs/configures itself to be able to transmit commands to each of the remote controlled devices corresponding to the received unique remote controlled device identifiers.

The present invention greatly simplify the end-user's process of teaching a universal remote control device the identity of the remote controlled devices, or individual commands of the remote controlled devices. Thus, the present invention provides an efficient and simple system and method for configuring a universal remote control device, requiring minimal effort by the user efforts.

### BRIEF DESCRIPTION OF THE DRAWINGS

For a complete understanding of the present invention and the advantages thereof, reference is now made to the following description taken in conjunction with the accompanying drawings in which like reference numbers indicate like features, components and method steps, and wherein:

FIG. 1 is an illustration of a system for the automatic configuring a universal remote control device in accordance with an exemplary embodiment of the present invention; and

FIG. 2 is a flow diagram showing the basic process flow for the automatic configuring of a universal remote control device in accordance with an exemplary embodiment of the present invention.

### DESCRIPTION OF A PRESENTLY PREFERRED EMBODIMENT

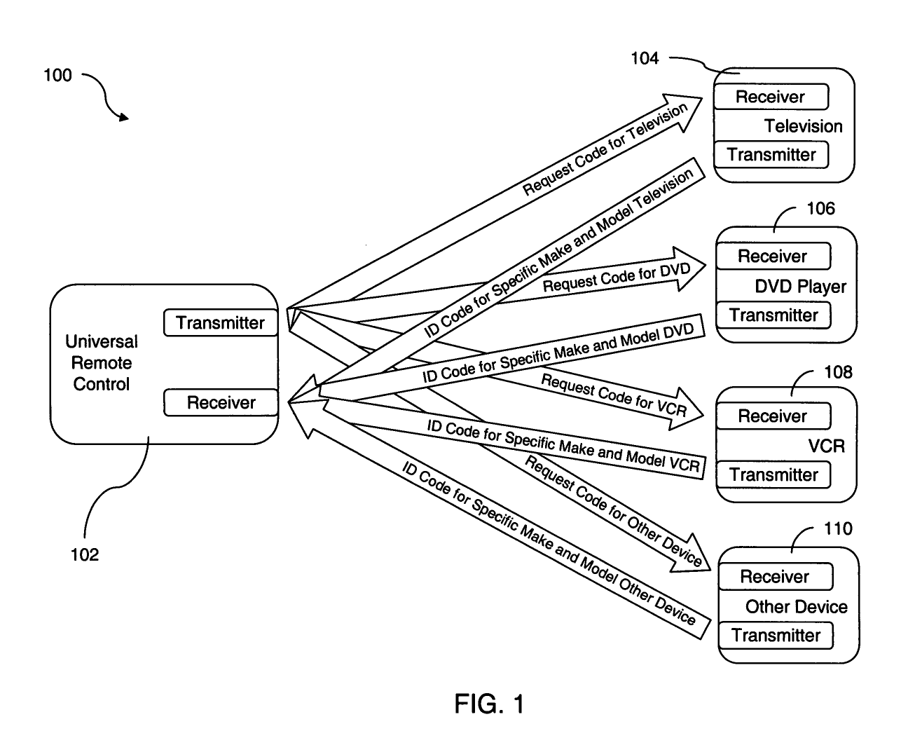

Referring to FIG. 1, system 100 is shown. System 100 is a system for the automatic configuring an inventive universal remote control device (“universal remote”) in accordance with an exemplary embodiment of the present invention. System 100 includes a universal remote 102, and a plurality of remote controlled devices 104, 106, 108, 110. Such remote controlled devices may include a television 104, DVD player 106, VCR 108, or any other end user device 110 capable of being controlled by a remote control signal, e.g., cable television set top box, satellite television tuner/receiver, DVR, etc. Universal remote 102 transmits and receives datum with remote controlled devices 104, 10, 108, 110 via infrared (“IR”) and/or radio frequency (“RF”) signals, depending on the signal format of remote controlled devices. (Both IR and RF are conventional used to control remote controlled devices.). The universal remote 102 include a transceiver, comprising of a transmitted and a receiver. The universal remote transmitter is used (1) to poll remote controlled devices for remote controlled device identifiers, as described below, and (2) to issue conventional remote control function commands to remote controlled devices. The universal remote 102 receiver is used to receive the remote controlled device identifiers. The universal remote 102 also includes a memory for storing unique remote controlled device identifiers and their corresponding conventional remote control commands.

Each remote controlled device 104, 106, 108, 110 also includes a transceiver, comprising of a transmitted and a receiver. Each remote controlled device's 104, 106, 108, 110 transmitter is used provide the remote controlled device identifiers in response to polling of the universal remote 102, as described below. Each remote controlled device's 104, 106, 108, 110 receiver is used (1) to receive a request, in the form of polling from the universal remote, for the remote controlled device's unique identifier and (2) to receive conventional remote control function commands sent to the remote controlled device.

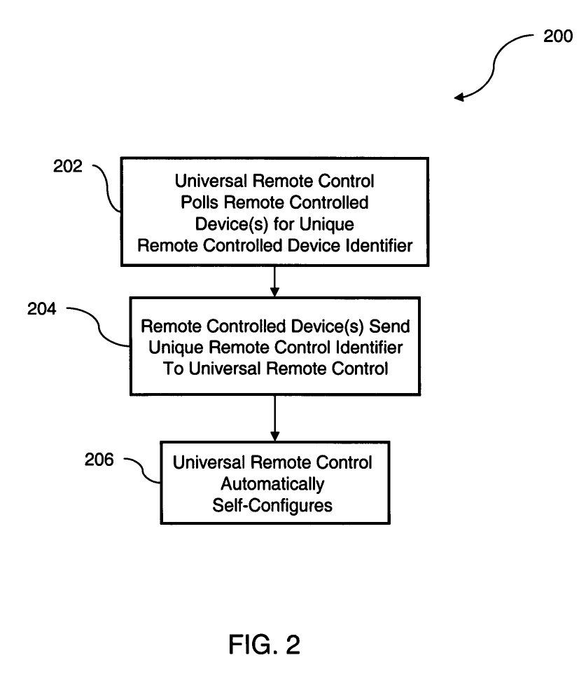

Referring to FIG. 2, in operation, upon initiation by an end user, the universal remote 102 polls remote controlled devices 104, 106, 108, 110 for each type of supported remote controlled device, e.g., television, VCR, DVR, DVD, etc., with a query that is unique for each type of device, in step 202. The end user initiation of the poll can be the click of a button on the universal remote. Alternatively, the polling can be automatically triggered on a state, such as replacement of batteries.

In response to such poll, each polled remote controlled device 104, 106, 108, 110 responds to the universal remote 102 with its unique device identifier (code), in step 204. The universal remote 102, in response to, and using, the received unique device identifier, automatically programs/configures itself to be able to transmit conventional remote control commands to said remote controlled device corresponding to the received unique device identifier, in step 206. Thus, instead of an end user attempting to look up a code pertaining to each remote controlled device 104, 106, 108, 110 to be controlled by the universal remote 102, universal remote 102 of the present invention automates this process by self-configuring in response to the unique device identifiers received from remote controlled devices 104, 106, 108, 110.

If the remote controlled devices 104, 106, 108, 110 are controlled by IR signals, the universal remote 102 must be aimed in the direction the remote controlled devices 104, 106, 108, 110 to send the poll and receive the unique device identifiers. If the remote controlled devices 104, 106, 108, 110 are controlled by RF signals, physical direction of the universal remote is not relevant.

The present invention does not require the end-user/consumer to know anything about the codes required to configure a universal remote control device or the remote controlled devices it commands. Further, the present invention reduces the process of configuring the universal remote to a simple button sequence, command by the end user, or state of the universal remote. Thus, the system and method of the present invention provide for a more efficient and simple configuration of a universal remote control device 102.

Although the invention has been described herein by reference to an exemplary embodiment thereof, it will be understood that such embodiment is susceptible of modification and variation without departing from the inventive concepts disclosed. For example, the universal remote and remote controlled devices may employ Bluetooth signalling to accomplish the above inventive system and method. All such modifications and variations, therefore, are intended to be encompassed within the spirit and scope of the appended claims.

We claim:

1. A system for the automatic configuring of a universal remote control device, said system comprising:
at least one remote controlled device; and
a universal remote control device transmittively coupled to said at least one remote controlled device, said universal remote control device sending a polling signal to said at least one remote controlled device requesting a unique remote controlled device identifier and receiving said unique remote controlled identifier from said at least one remote controlled device.

2. The system of claim 1 wherein said at least one remote controlled device comprises a transceiver.

3. The system of claim 2 wherein said transceiver comprises an infrared transceiver.

4. The system of claim 2 wherein said transceiver comprises an radio frequency transceiver.

5. The system of claim 1 wherein said universal remote control device comprises a transceiver.

6. The system of claim 5 wherein said transceiver comprises an infrared transceiver.

7. The system of claim 5 wherein said transceiver comprises an radio frequency transceiver.

8. An automatic self configuring universal remote control device comprising:
a transceiver, said transceiver further comprising:
a transmitter, said transmitter sending a polling signal to at least one remote controlled device, said polling signal requesting a unique remote controlled device identifier;
a receiver, said receiver receiving said unique remote controlled identifier from said at least one remote controlled device; and
a memory, said memory containing command datum for said unique remote controlled identifier.

9. The system of claim 8 wherein said transceiver is an infrared transceiver.

10. The system of claim 8 wherein said transceiver is a radio frequency transceiver.

11. A remote controlled device for automatic configuration of a universal remote control device, said remote controlled device comprising:
a transceiver, said transceiver further comprising:
a receiver, said receiver receiving a polling signal from a universal remote control device requesting a unique remote controlled device identifier; and
a transmitter, said transmitter sending said unique remote controlled identifier to said universal remote control device.

12. The system of claim 11 wherein said transceiver is an infrared transceiver.

13. The system of claim 11 wherein said transceiver is a radio frequency transceiver.

14. A method for automatically configuring a universal remote control device, said method comprising:
sending a polling signal to at least one remote controlled device, said polling signal requesting a unique remote controlled device identifier;
receiving said unique remote controlled identifier from said at least one remote controlled device; and
configuring commands based upon said unique remote controlled device identifier.

15. The method of claim 14 wherein said step of configuring commands comprises accessing a memory to provide configuration datum for said unique remote controlled device identifier.

16. The method of claim 14 wherein the step of sending a polling signal comprises polling at least one remote controlled device for each type of supported remote controlled device with a query that is unique for each type of remote controlled device.

17. A method for automatically configuring a universal remote control device, said method comprising:
receiving a polling signal from a universal remote control device, said polling signal requesting a unique remote controlled device identifier; and
sending said unique remote controlled identifier to said universal remote control device in response to said polling signal.
